(19) United States
(12) Patent Application Publication
(10) Pub. No.: US 2019/0082765 A1
(43) Pub. Date: Mar. 21, 2019

(54) INTEGRATED HEADWEAR AND HEADLIGHT SYSTEM AND METHOD

(71) Applicants: Jay-B Manning, Edson (CA); Brian Janish, Edson (CA)

(72) Inventors: Jay-B Manning, Edson (CA); Brian Janish, Edson (CA)

(21) Appl. No.: 15/710,009

(22) Filed: Sep. 20, 2017

(51) Int. Cl. A42B 3/04; F21V 23/04; F21V 14/02; F21V 17/02; F21V 23/06; F21V 21/084; F21V 7/00; F21L 4/02; F21V 17/12; H05B 33/08; F21V 3/04

(52) U.S. Cl. CPC A42B 3/0446; F21V 23/0414; F21V 14/025; F21V 17/02; F21V 23/06; F21Y 2115/10; F21V 7/00; F21L 4/02; F21V 17/12; H05B 33/0845; F21V 3/0409; F21V 21/084

(57) ABSTRACT

An integrated headwear and headlight system includes a headwear having an exterior and a recess wherein the recess has at least one edge. The recess is configured to receive a lamp housing nested within the recess. An energy source is affixed onto the integrated headwear and headlight system. A light source is coupled mechanically within the lamp housing and electrically coupled to the energy source. A window with a latch is pivotably connected on at least one edge of the recess. The window is configured to cover the recess when in its latched position. A toggle button is mounted to actuate the light source and a controller circuit changes the brightness and modes of operation. The integrated headwear and headlight system is useful for providing light in work environments.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of headwear of existing art and more specifically relates to lighted headwear.

### RELATED ART

Typically, work environments require a basic set of equipment that allows a worker to complete their job in a safe and effective way. The standard set of equipment generally includes personal protective equipment (PPE) and a device to provide sufficient illumination to a workspace. Personal protective equipment is a diverse range of gear that is specific to the particular work environments requirements. This personal protective equipment includes protective apparel such as gloves, heavy garments to cover the body, and almost in every circumstance a protective headwear. Headwear in work environments must be approved by standards committees and rated as being able to protect a head from various impacts, typically vertical-impacts and lateral-impacts.

Those familiar with work environments where industrial grade headwear is required are aware that the most necessary utility to reinforce a safe work environment is proper lighting. Typically, an auxiliary tool for illumination is carried on a workers' person. This may come in the form of a flashlight that must occupy space on a toolbelt when not in use and occupy the full use of an extremity when being used.

U.S. Pub. No. 2013/0265745 to Troy D. Fischer relates to a light integrated hardhat. The described light integrated hardhat includes light integrated hard hat that includes a protective head covering having a crown and a brim. A casing has an open window, whereby the casing is formed on a front portion of the crown and on the brim of the protective head covering. A first mechanism is for producing an illumination carried within the casing behind the open window. A second mechanism is for supplying electrical power to the illumination producing mechanism, so as to provide a projected focused beam through the open window of the casing.

### SUMMARY OF THE INVENTION

In view of the foregoing disadvantages inherent in the known lighted headwear art, the present disclosure provides a novel integrated headwear and headlight system. The general purpose of the present disclosure, which will be described subsequently in greater detail, is to provide an integrated headwear and headlight.

An integrated headwear and headlight is disclosed herein. The integrated headwear and headlight system comprises a headwear having an exterior and a recess; wherein the recess has at least one edge. An energy source is affixed to the headwear and electrically connected to a light source. The light source is mechanically coupled within a lamp housing unit which is nested within the recess of the headwear. A window with a latch is pivotably connected to the recess of the helmet. The window pivots to cover the light source between a latched configuration being closed and an unlatched configuration being open. A toggle button to actuate the light source is located on the exterior of the headwear, and a controller is connected to the button to operate the various modes of the light source.

According to another embodiment, a method for using an integrated headwear and headlight system is also disclosed herein. The method for using an integrated headwear and headlight system includes firstly, providing an integrated headwear and headlight system, the integrated headwear and headlight system comprising: a headwear having an exterior and a recess, wherein the recess has at least one edge; a lamp housing nested within the recess of the headwear; an energy source affixed to the headwear; a light source mechanically coupled to the lamp housing and electrically coupled to the energy source; a window pivotably connected to the recess on the at least one edge, wherein the window further includes a latch, wherein the window pivots between a latched configuration being closed, and an unlatched configuration being open, wherein the window covers the light source in a latched configuration; a toggle button electrically connected to the light source, the toggle button being configured to actuate the light source; a controller electrically coupled to the energy storage and the toggle button, the controller being configured to adjust the light source; secondly, inserting batteries into the energy source; thirdly, placing lamp housing with light source into the recess; fourthly, fastening the lamp housing into the recess through the aperture; fifthly, latching the window closed over the recess to cover the light source; sixthly, fastening the window in a closed position with the aperture; and seventhly, pressing the toggle button to turn on the light;

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an integrated headwear and headlight, constructed and operative according to the teachings of the present disclosure.

FIG. 1 is a perspective view of the integrated headwear and headlight system during an ‘in-use’ condition, according to an embodiment of the disclosure.

FIG. 2 is another perspective view of the integrated headwear and headlight system of FIG. 1, according to an embodiment of the present disclosure.

FIG. 3 is another view of the integrated headwear and headlight system of FIG. 1, according to an embodiment of the present disclosure.

FIG. 4 is yet another view of the integrated headwear and headlight system of FIG.

1, according to an embodiment of the present disclosure.

FIG. 5 is a flow diagram illustrating a method to provide light in a work environment with an integrated headwear and headlight system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a lighted headwear and more particularly to integrated headwear and headlight system as used to improve the providing light in a work environment.

Generally, integrated headwear and headlight system comprises a headwear having an exterior and a recess, wherein the recess has at least one edge. The headwear is an industrial hardhat that meets the standards set forth by both the American National Standards Institute (ANSI) and the Canadian Standards Association (CSA) encompassing both vertical-impact (Type I) and lateral-impact (Type II) protection standards as well as having a voltage-tolerance of 2200V±3% (Class G).

The recess in the headwear is substantially rectangular in shape, wherein a lamp housing unit of similar shape to the recess contains a light source comprising at least one light-emitting diode (LED), which is nested and fastened within the recess. An energy source is affixed to the headwear and electrically connected to the light source. The energy source affixed to the headwear is configured to receive AAA class batteries and alternatively AA class batteries. The lamp housing unit is equipped with terminals in electrical contact with an energy source. The interior of the lamp housing has at least one reflective surface to concentrate the light emitted from the light source. A window with a latch is pivotably connected to the recess of the helmet. The window pivots to cover the light source between a latched configuration being closed and an unlatched configuration being open. A toggle button is connected to the exterior of the headwear and used to turn the light on and off and to cycle between modes of operation. A controller circuit is used to switch between various modes of light operation such as brightness and flashing functions.

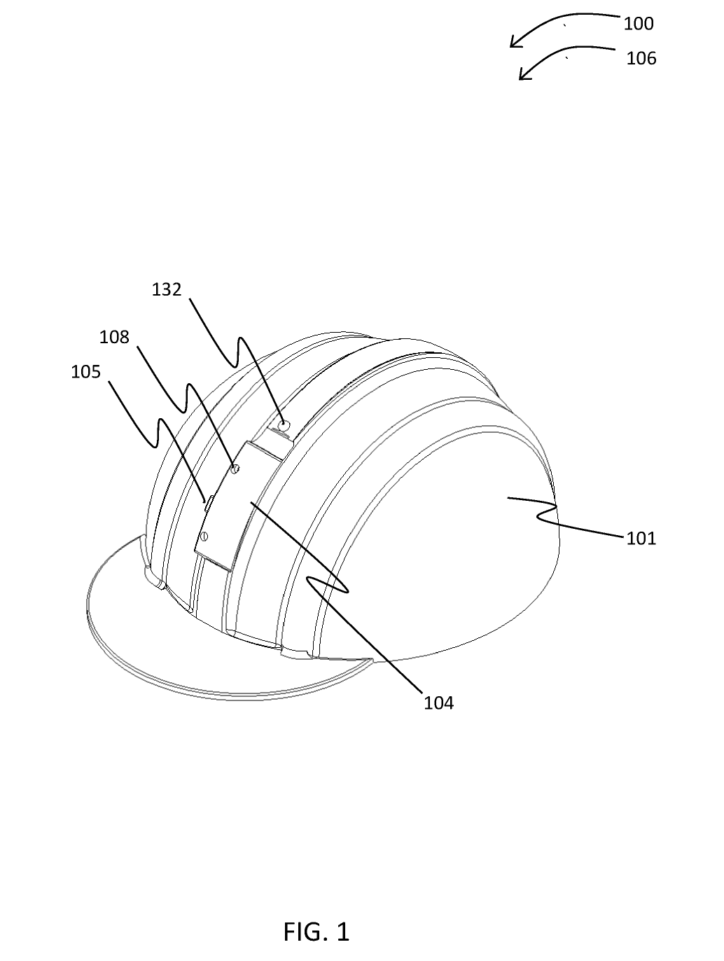

Referring now more specifically to the drawings by numerals of reference, there is shown in FIGS. 1-4, various views of an integrated headwear and headlight system 100.

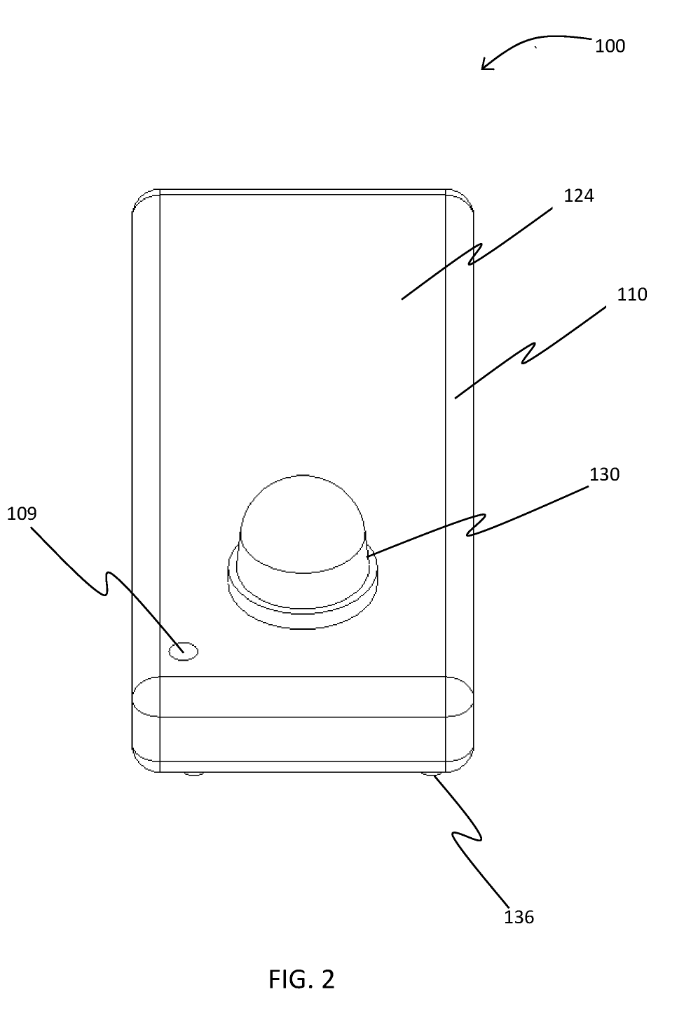

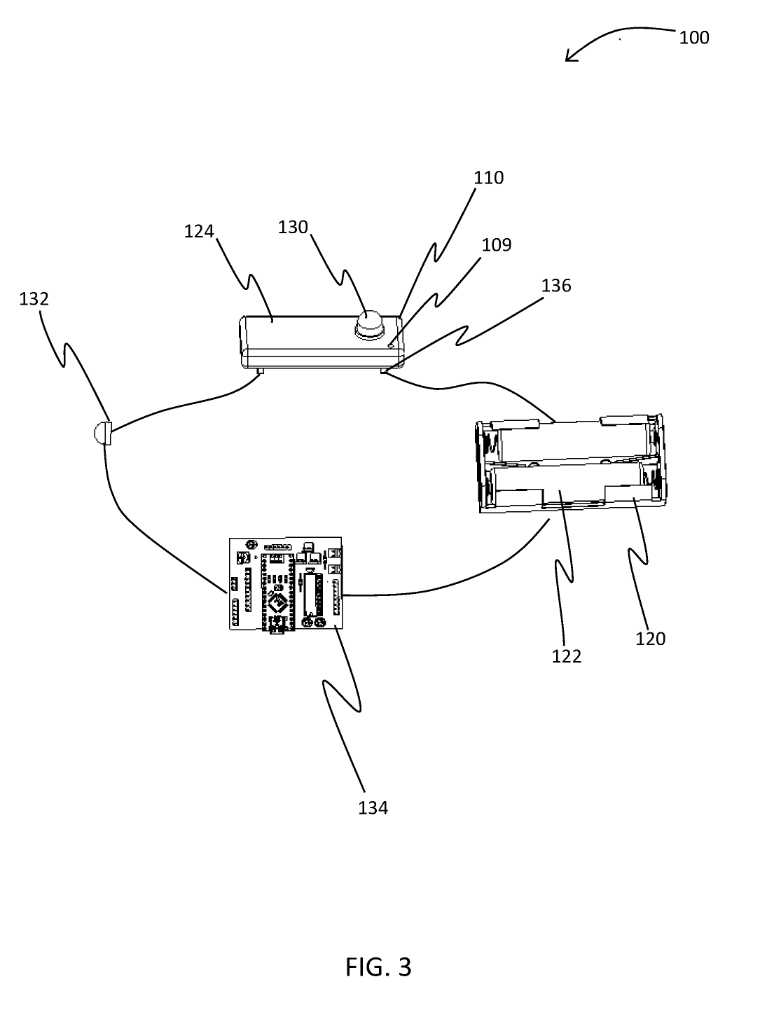

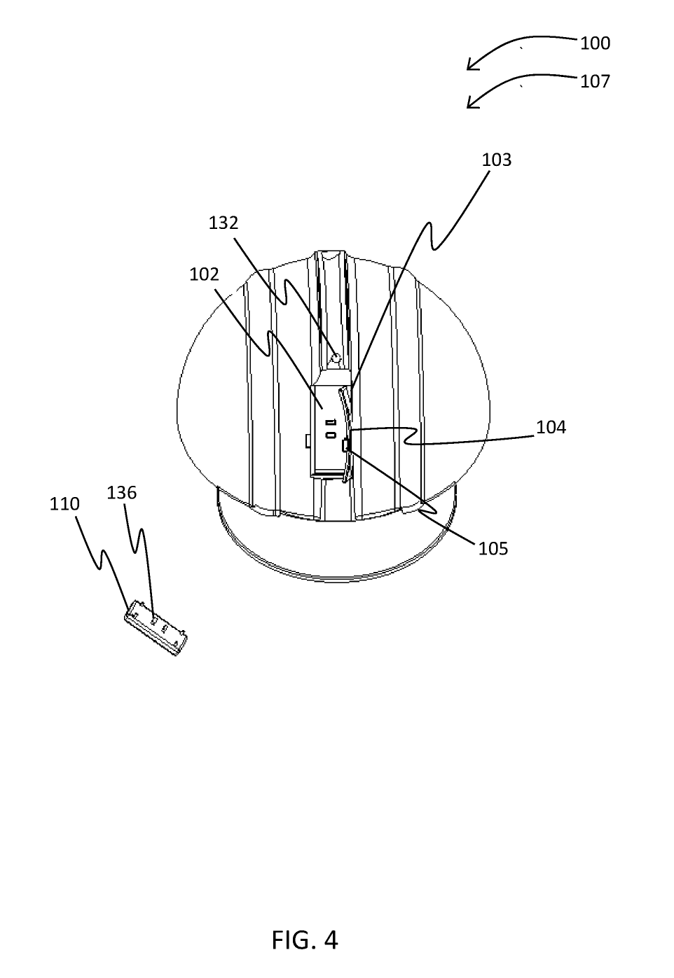

FIG. 1 shows an integrated headwear and headlight system 100 during an ‘in-use’ condition, according to an embodiment of the present disclosure. Here, the integrated headwear and headlight system 100 may be beneficial for use by a user 40 to provide light in a work environment. As illustrated, the integrated headwear and headlight system 100 may include an exterior 101 and a recess 102 wherein the recess 102 has at least one edge 103. A lamp housing 110 (FIG. 2) is nested within the recess 102 and affixed in position through a fastening aperture 109. An energy source 120 is connected to the headwear 100 to power a light source 130 (FIG. 2). The light source 130 is mechanically coupled within the lamp housing 110. A window 104 is pivotably attached to at least one edge 103 of the recess 102 (FIG. 4). The window 104 further includes a latch 105 wherein the window 104 pivots between a latched configuration 106 and an unlatched configuration 107. A fastening aperture 108 is located on the window 104 to retain a latched configuration 106. A toggle button 132 is affixed to the exterior 101 of the headwear 100 and is used to actuate the light source 130 (FIG. 2). A controller 134 (shown in FIG. 3) is electrically connected to the toggle button 132 and is used to control the various modes of brightness and other flashing functions of the light source 130.

FIG. 2 shows the integrated headwear and headlight system 100 of FIG. 1, according to an embodiment of the present disclosure. As above, the integrated headwear and headlight system 100 may include a lamp housing 110 that is substantially rectangular in shape. Within the lamp housing is a light source 130 comprising at least one light emitting diode (LED). The lamp housing 110 has at least one reflective surface 124 to concentrate the light emitted from the light source 130. Further a lamp housing aperture 109 is included as part of the lamp housing 110 structure. Terminals 136 are located on the lamp housing 110 and connected to the light source 130.

FIG. 3 is another view of the integrated headwear and headlight system 100 of FIG. 1, according to an embodiment of the present disclosure. As above, the integrated headwear and headlight system 100 may include a lamp housing 110 with at least one reflective surface 124 and lamp housing aperture 109 to retain the lamp housing 110. Mechanically connected within the lamp housing 110 is a light source 130 which is connected to the terminals 136 of the lamp housing 110. This embodiment illustrates that the toggle button 132, the controller 134 and the energy source 120 are all connected in a similar circuit. Further illustrated the energy source 120 is configured to receive batteries 122.

FIG. 4 is another view of the integrated headwear and headlight system 100 of FIG. 1, according to an embodiment of the present disclosure. Illustrated is an exploded view of the integrated headwear and headlight system 100 showing where the window 104 with a latch 105 has pivoted along at least one edge 103 of the recess 102 to an unlatched configuration 107. Corresponding terminals 136 are illustrated within the recess 102 and on the lamp housing 110.

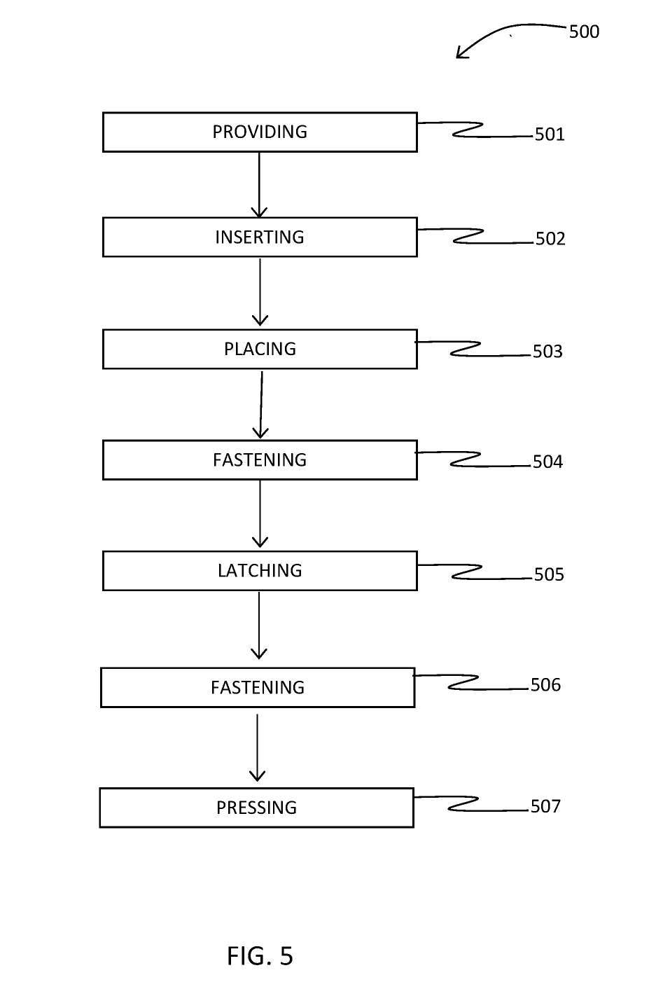

FIG. 5 is a flow diagram illustrating a method 500 for using an integrated headwear and headlight system 100, according to an embodiment of the present disclosure. In particular, the method for using 500 an integrated headwear and headlight system 100 may include one or more components or features of the integrated headwear and headlight system 100 as described above. As illustrated, the method 500 for providing light in work environments may include the steps of: step one 501, providing an integrated headwear and headlight system, the integrated headwear and headlight system comprising: a headwear having an exterior and a recess, wherein the recess has at least one edge; a lamp housing nested within the recess of the headwear; an energy source affixed to the headwear; a light source mechanically coupled to the lamp housing and electrically coupled to the energy source; a window pivotably connected to the recess on the at least one edge, wherein the window further includes a latch, wherein the window pivots between a latched configuration being closed and an unlatched configuration being open, wherein the window covers the light source in a latched configuration; a toggle button electrically connected to the light source, the toggle button being configured to actuate the light source; a controller electrically coupled to the energy storage and the toggle button, the controller being configured to adjust the light source; step two 502, inserting batteries into the energy source; step three 503, placing lamp housing with light source into the recess; step four 504, fastening the lamp housing into the recess through the aperture; step five 505, latching the window closed over the recess to cover the light source; step six 506, fastening the window in a closed position with the aperture; and step seven 507, pressing the toggle button to turn on the light.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for providing light in a work environment, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An integrated headwear and headlight system, the integrated headwear and headlight system comprising:
a headwear having an exterior and a recess, wherein the recess has at least one edge;
a lamp housing nested within said recess of said headwear;
an energy source affixed to the headwear;
a light source mechanically coupled to said lamp housing and electrically coupled to said energy source;
a window pivotably connected to said recess on said at least one edge, wherein said window further includes a latch, wherein said window pivots between a latched configuration being closed and an unlatched configuration being open, wherein said window covers said light source in a latched configuration;
a toggle button electrically connected to said light source, said toggle button being configured to actuate said light source; and
a controller electrically coupled to said energy storage and said toggle button, said controller being configured to adjust said light source.

2. The integrated headwear and headlight system of claim 1, wherein said headwear is a Type I vertical-impact protection hardhat as defined by ANSI Z89.1.

3. The integrated headwear and headlight system of claim 2, wherein said headwear is a Type II lateral-impact protection hardhat as defined by ANSI Z89.1.

4. The integrated headwear and headlight system of claim 2, wherein hardhat has a voltage tolerance of 2200V±3% to as defined by CSA Standard Z94.1-15

5. The integrated headwear and headlight system of claim 2, wherein said headwear is sufficiently rigid to provide impact and penetration protection from lateral-impacts and vertical-impacts.

6. The integrated headwear and headlight system of claim 1, wherein said recess of said headwear is of substantially rectangular shape.

7. The integrated headwear and headlight system of claim 1, wherein said lamp housing is contoured to fit within said recess of said headwear.

8. The integrated headwear and headlight system of claim 1, wherein said lamp housing further includes electrical terminals configured to receive electricity from said energy source, said electrical terminals being in electrical communication with said light source.

9. The integrated headwear and headlight system of claim 1, wherein said lamp housing further includes fastening means for coupling said lamp housing to said recess of said headwear, such that said lamp housing is nested within said recess of said headwear.

10. The integrated headwear and headlight system of claim 1, wherein said lamp housing further includes at least one reflecting surface configured to concentrate said light source.

11. The integrated headwear and headlight system of claim 1, wherein said energy source further includes one or more batteries, said batteries being removable and replaceable from said energy source.

12. The integrated headwear and headlight system of claim 11, wherein said batteries comprise AAA class batteries and alternatively AA class batteries.

13. The integrated headwear and headlight system of claim 1, wherein said light source comprises at least one light-emitting diode (LED).

14. The integrated headwear and headlight system of claim 1, wherein said window is flush with said recess of said headwear when said window is in said latched configuration.

15. The integrated headwear and headlight system of claim 1, wherein said window comprises a shatter-resistant material.

16. The integrated headwear and headlight system of claim 1, wherein said window further includes at least one aperture wherein the aperture is configured for a screw, wherein the screw is configured to fasten the window in a latched position.

17. The integrated headwear and headlight system of claim 1, wherein toggle button is attached to said exterior of said headwear.

18. The integrated headwear and headlight system of claim 1, wherein said controller is configured to adjust a brightness of said light source, said controller having a plurality of selectable modes relative to said brightness of said light source.

19. A headwear with an integrated headlight comprising:
a headwear having an exterior and a recess, wherein the recess has at least one edge;
a lamp housing nested within said recess of said headwear;
an energy source affixed to the headwear;
a light source mechanically coupled to said lamp housing and electrically coupled to said energy source;
a window pivotably connected to said recess on said at least one edge, wherein said window further includes a latch, wherein said window pivots between a latched configuration being closed and an unlatched configuration being open, wherein said window covers said light source in a latched configuration;
a toggle button electrically connected to said light source, said toggle button being configured to actuate said light source; and
a controller electrically coupled to said energy storage and said toggle button, said controller being configured to adjust said light source;
wherein said headwear is a Type I vertical-impact protection hardhat as defined by ANSI Z89.1;
wherein hardhat has a voltage tolerance of 2200V±3% to as defined by CSA Standard Z94.1-15;
wherein said headwear is sufficiently rigid to provide impact and penetration protection from lateral-impacts and vertical-impacts;
wherein said recess of said headwear is of substantially rectangular 3D shape;
wherein said lamp housing is contoured to fit within said recess of said headwear;
wherein said lamp housing further includes electrical terminals configured to receive electricity from said energy source, said electrical terminals being in electrical communication with said light source;
wherein said lamp housing further includes fastening means for coupling said lamp housing to said recess of said headwear, such that said lamp housing is nested within said recess of said headwear;
wherein said lamp housing further includes at least one reflecting surface configured to concentrate said light source;
wherein said energy source further includes one or more batteries, said batteries being removable and replaceable from said energy source;
wherein said batteries comprise AAA class batteries and alternatively AA class batteries;
wherein said light source comprises at least one light-emitting diode;
wherein said window is flush with said recess of said headwear when said window is in said latched configuration;
wherein said window comprises a shatter-resistant material;
wherein said window further includes at least one aperture wherein the aperture is configured for a screw, wherein the screw is configured to fasten the window in a latched position;
wherein a toggle button is attached to said exterior of said headwear;
wherein said controller is configured to adjust a brightness of said light source, said controller having a plurality of selectable modes relative to said brightness of said light source.

20. A method for using an integrated headwear and headlight system, the method comprising the steps of:
providing an integrated headwear and headlight system, said integrated headwear and headlight system comprising: a headwear having an exterior and a recess, wherein the recess has at least one edge; a lamp housing nested within said recess of said headwear;
an energy source affixed to the headwear; a light source mechanically coupled to said lamp housing and electrically coupled to said energy source; a window pivotably connected to said recess on said at least one edge, wherein said window further includes a latch, wherein said window pivots between a latched configuration being closed and an unlatched configuration being open, wherein said window covers said light source in a latched configuration; a toggle button electrically connected to said light source, said toggle button being configured to actuate said light source; a controller electrically coupled to said energy storage and said toggle button, said controller being configured to adjust said light source.
inserting batteries into the energy source;
placing lamp housing with light source into the recess;
fastening the lamp housing into the recess through the aperture;
latching the window closed over the recess to cover the light source;
fastening the window in a closed position with the aperture; and
pressing the toggle button to turn on the light;
